(19) United States
(12) Patent Application Publication
(10) Pub. No.: US 2003/0221633 A1
(43) Pub. Date: Dec. 4, 2003

(54) Animal amusement tugging device

(76) Inventors: Neil J. Werde, Scottsdale, AZ (US); Martin J. Caveza, Redondo Beach, CA (US)

Correspondence Address: KENYON & KENYON, One Broadway, New York, NY, 10004, US

(21) Appl. No.: 10/156,375

(22) Filed: May 28, 2002

(51) Int. Cl. A01K 29/00

(52) U.S. Cl. 119/707

(57) ABSTRACT

The invention provides an animal play toy with a surface, a handle, a housing defining an interior volume, and a spring arrangement connected to the animal mouthpiece and the handle, the spring arrangement positioned in the interior volume. The invention further describes a method of playing with an animal. A method provides gripping a handle, placing a mouthpiece in an animal's mouth, placing a force between the handle and the mouthpiece, and measuring the force between the handle and the mouthpiece.

### FIELD OF THE INVENTION

The present invention relates to an animal/human amusement device. More specifically, the invention relates to a device which allows an animal and an animal handler to interact in a pulling contest while the animal and the animal handler are encouraged by the device during the contest.

### BACKGROUND INFORMATION

Animals, especially dogs, have a natural tendency to engage in playful activity with their handler. One activity commonly enjoyed by handler and animal alike is a classic tug-o-war, where the handler and the animal try to pull an object away from each other. Animals and animal handlers have enjoyed this activity for ages, however, certain limitations are inherent in the objects used.

Towels can cause other negative impacts on an animal's health. Towels often become contaminated with pathogens, potentially affecting the animal's digestion. Foreign materials contained in the towel may also easily enter the eyes or nose of the animal. Additionally, the towel may rip during play causing the animal, handler or both to lose balance increasing risk of injury.

The use of towels also often requires that the animal pull biased to one side, consequently placing stress on the neck, shoulders and spinal column. Towels, furthermore, provide little to no interaction with the animal or handler during play. The lack of interaction often results in the handler and/or animal becoming quickly disinterested in the activity.

The use of typical materials have another significant drawback. Typical materials do not encourage the animal and/or handler during the contest. Over time, both the animal and handler may become bored due to the lack of change and excitement.

Accordingly, there is a need to provide an apparatus which allows an animal and an animal handler to engage in a tugging contest with no adverse health impacts on the animal. There is also a need to provide a device which will interact with the animal and handler increasing the enjoyment of the activity for both.

### SUMMARY

It is therefore an object of the present invention to provide a device which allows an animal and an animal handler to engage in a tugging contest with no adverse health impacts to the animal.

It is also an object of the present invention to provide a device which will interact with the animal and handler increasing the enjoyment of the activity for both.

These and other objects of the invention, which will become apparent from the following detailed description, are achieved as described. An animal play toy is disclosed. The animal play toy comprises a housing defining an interior volume, an animal mouthpiece, a handle connected to the housing, and a resistance arrangement connected to the animal mouthpiece and the housing, the resistance arrangement positioned in the interior volume.

A method of playing with an animal is also described. The method comprises gripping a handle, placing a mouthpiece in an animal's mouth, creating a force between the mouthpiece and the handle, and measuring the force between the handle and the mouthpiece.

### BRIEF DESCRIPTION OF THE DRAWINGS

FIG. 1 illustrates an animal amusement tugging device in conformance with the present invention.

FIG. 2 illustrates a back view of the device of FIG. 1.

FIG. 3 illustrates an example resistance arrangement.

FIG. 4 illustrates an example electrical circuit of the device of FIG. 1.

### DETAILED DESCRIPTION

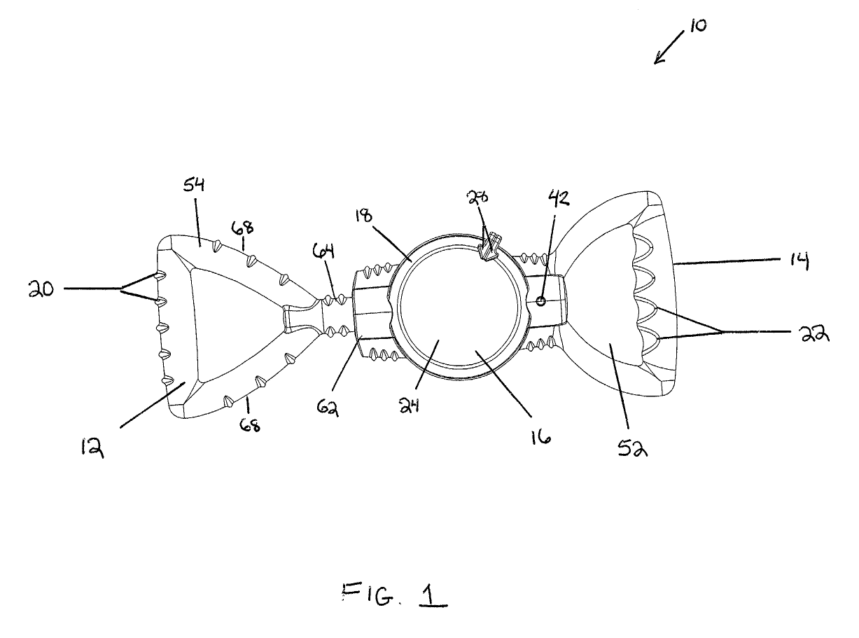

Referring to FIG. 1, a device 10, in conformance with the present invention is shown. The device 10 may be comprised of an animal mouthpiece 12, a handle 14, a housing 16 and a resistance arrangement 46 connected to the animal mouthpiece 12 and the housing 16.

The handle 14 may be used by a handler to provide an anchor point in a tugging contest with an animal. The handle 14 allows the handler to insert a hand or grasping object through an opening 52 allowing a proper grip to be established. The handle 14 may be configured with finger indentations 22 to provide a superior gripping geometry and additionally may be sized to allow the handle to be grabbed in a one or two handed manner. The handle 14, may also be sized for children or adults. The handle 14 may be manufactured from high impact plastic, ABS, or other material which will provide lightness of weight while having sufficient tensile and shear capacity for anticipated loads. The handle 14 may be colored to provide an eye-catching design. A surface for the handle 14 may be covered with a non-skid material to enhance gripping traction. The no-skid material may include an exterior placed rubber coating. Additionally, a textured surface may be formed during manufacturing. The handle 14 may additionally be configured to allow rotation relative to the housing 16, to minimize stress on the wrist of the handler during play. The handle 14 may be configured in multiple pieces joined by screws 30 to form a coherent unit.

A mouthpiece 12 is provided to allow an animal biting point for the device 10. The mouthpiece 12 may be shaped in a variety of configurations and as such the configuration shown should not be considered limiting. The mouthpiece 12 may be configured with a surface 54 which allows for a friction fit in an animal's mouth during biting. The surface 54 may be varied according to the type of friction required. The surface 54, for example, may have a geometrical configuration with bumps or stubbles 20. Furthermore, the surface 54 may be covered with a material such as high strength non-toxic rubber, to enhance friction in an animal's mouth. The body of the mouthpiece 12 may be manufactured of high impact plastic or other material suitable for anticipated sheer and bending loads. The mouthpiece 12 may also be formed such that a non-breaking rope extends between the sides 68 of the mouthpiece, encouraging the animal to grasp the mouthpiece 12.

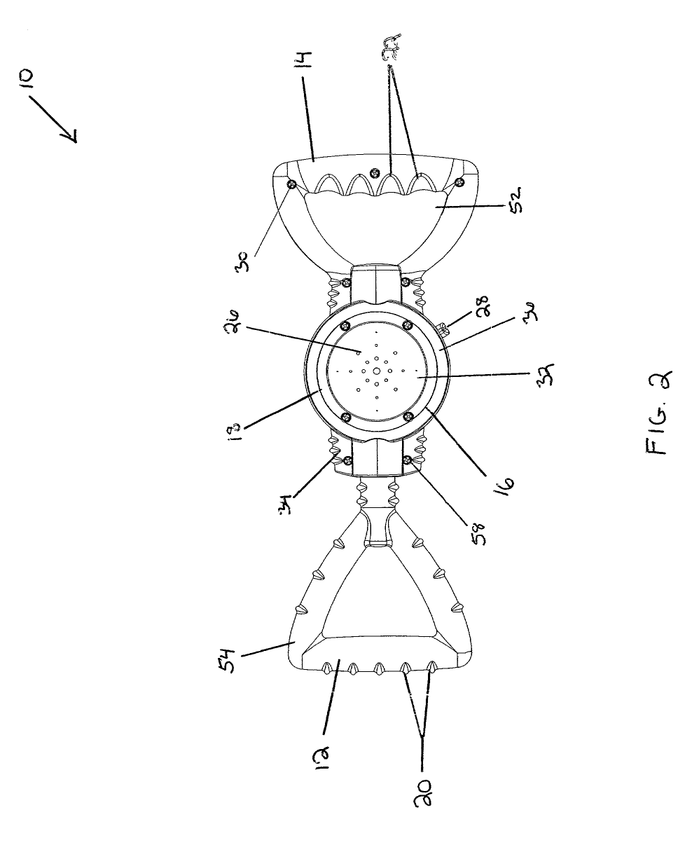

A housing 16 provides a connection point for the device 10 allowing the handle 14 and the mouthpiece 12 to be joined. In the configuration illustrated, the mouthpiece 12 is constructed as an inner tube 62. The inner tube 62 may fit within an outer tube 64 formed with the housing 16. The installation of a resistance arrangement 46 may keep the mouthpiece 12 in a retracted state. Both the inner tube 62 and the outer tube 64 may be manufactured from nylon or other similar material to provide for acceptable sheer and bending strength as well as lightness of weight. The housing 16 defines an interior volume 18 which may house a resistance arrangement 46, processing unit 50, power source 44 and force measuring unit 48. The housing 16 may be manufactured in as many parts as necessary to perform the housing function. In the illustrated views of FIG. 1 and FIG. 2, a two part housing 16 is shown in which a housing first part 34 and housing second part 36 define the interior volume 18. The housing first part 34 and the housing second part 36 are joined through a connection arrangement 56. As shown, the connection arrangement 56 may be comprised of set screws 58. As will be identified by those skilled in the art, the set screws 58 may extend into pre-formed screw acceptors in the opposite housing part. The housing 24 may have an optional label area 24 for the attachment of a logo or other design/artwork application. The logo or design /artwork application may either be performed through the use of a sticker or actual formation into the housing 16 during manufacturing. The housing 16 may be manufactured from high impact plastic as an example for strength or other appropriate material.

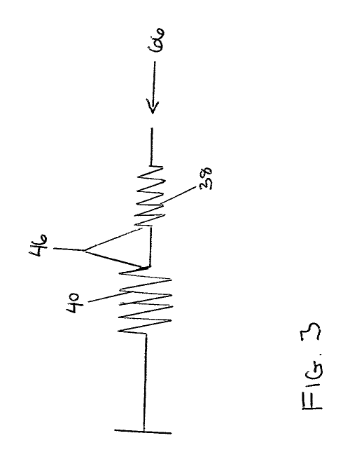

Referring to FIG. 3, an example resistance arrangement 46 for the device 10 is shown. The resistance arrangement 46 may be comprised of a spring or springs, for example, to provide resistance during the tugging contest. The springs 38, 40 provide sufficient “give” to enable the animal to pull without significant shock stresses being placed on the animal through sudden impact. As illustrated in FIG. 3, a series of two springs 38,40 provide the resistance of the device 10. In the example embodiment shown, a first spring 38 is positioned in series with a larger second spring 40 to allow two modes of playful interaction. The first spring 38 may be configured with a spring constant which is relatively small compared to the spring constant of the second spring 40. Once a force is placed on the resistance arrangement 46, the first spring 38, due to its lesser spring constant, will deflect first as compared to the second spring 40. Once the first spring 38 has deflected to a maximum threshold, the second spring 40 may be progressively deflected. By configuring the first spring 38 and the second spring 40 in this manner, lighter animals with lesser tugging capability may enjoy the movement provided by the device 10. Larger animals, meanwhile, after deflecting the relatively “soft” first spring 38, will find the device 10 challenging for their increased tugging capabilities. Other configurations are possible, for example, a three spring series arrangement may provide for a “low”, “medium” and “high” strength capacity of the unit. Likewise, the device 10 may be configured for only larger or smaller animals and have a single spring. In the arrangement 46 shown, a typical spring constant for the first spring 38 may be, for example 40 pounds per inch deflection. A typical spring constant for the second spring 40 maybe, for example 120 pounds per inch deflection. Other spring constant values may be used depending upon the strength and weight of the animal the device 10 is designed for. When a force 66 is placed upon the arrangement 46, the mouthpiece 12 may be drawn out of the housing 16 such that the inner tube 64 slides out of the outer tube 62 to a degree allowed by the springs 38, 40. Additional arrangements may be used including hydraulic pistons, elastic bands or other similar arrangements. The springs 38, 40 may be manufactured of non-fatigue prone material to allow repeated stress cycles. The springs 38, 40 may be manufactured of steel, or high strength plastic as an example.

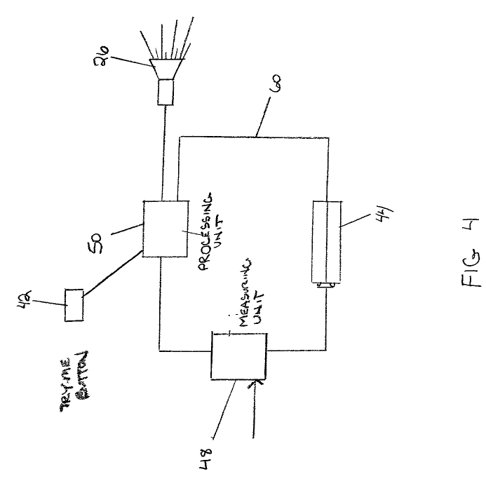

Referring to FIG. 4, an example circuit 60 is shown. The circuit 60 may be comprised of a measuring unit 48, a processing unit 50, a button 42, a loudspeaker 26 and a power source 44. A measuring unit 48 may be configured to monitor the resistance arrangement 46 to determine the amount of force on the arrangement at any time. The measuring unit 48 may be preprogrammed to measure the force on an instantaneous basis or a sample over time basis. Information obtained by the measuring unit 48 may be conveyed to a processing unit 50. The processing unit 50 may allow input of the conveyance of the measuring unit 48 and compares the information obtained with a pre-set range of threshold values. If a threshold value is exceeded by the measurements obtained by the measuring unit 48, the processing unit 50 may be activated to provide an output. In the example embodiment shown, a loudspeaker 26 provides an audio output. Typical audio output initiated by the processing unit 50, may provide, for example, words of encouragement for the animal and the handler that a certain level has been achieved. As will be identified by those skilled in the art, a range of differing thresholds may be established in which differing outputs may be provided for differing levels of achievement. The processing unit 50 may similarly use a randomizing function to mix the outputs in a more random manner to surprise the animal and handler upon successive levels of achievement. The processing unit 50 may also be configured with an internal memory to allow retention of data from different play sessions, allowing the handler to track the capability of the animal over time.

A power source 44 provides the needed energy for the circuit 60. The power source 44 may be any type of energy delivery device to provide sufficient electrical supply to the circuit 60. As shown in FIG. 4, batteries, for example AA size, may be used to power the circuit 60. The power source 44, may be replaceable and/or rechargeable, for example, to allow for continued use of the device 10 once power drain of the power source 44 is complete.

A loudspeaker 26 may be attached to the processing unit 50 to provide a feedback to the animal and the handler during play. The loudspeaker 26 may be sized according to the power source 44 available for the device 10. The loudspeaker 26 may be adjustable such that sound volume level may be either turned off or placed at a maximum volume. The loudspeaker 26 may be configured such that volume levels are safe for use by children and animals. The loudspeaker 26 may further be configured to be weatherproof to allow the unit to function in wet environments. The loudspeaker 26 may be configured as an attachment to the exterior of the housing 16 or as a unit which is internal to the housing 16. If placed in the housing 16, appropriate holes may be placed in a loudspeaker cover 32 in the housing 16 to allow sound penetration for the loudspeaker 26 during activation.

A button 42 may be located on the device 10 to allow potential users to test the device 10 for battery power levels or to sample the capabilities of the device 10. The button 42 may therefore be connected to the processing unit 50 to provide a direct initiation of the loudspeaker 26 of the device 10. In the embodiment shown in FIG. 1, the button 42 is configured as a “try me” button 42 which allows a user to “scroll” through the differing sounds that the device 10 may make.

A meter 28 may allow a handler to determine the total force that has been exerted during the tugging contest. The meter 28 allows the handler to see the accomplishments of the animal and allow the handler to track progress in strength over time. As shown in an example embodiment, the meter 28 automatically deflects based upon the amount of force exerted on the resistance arrangement 46. The meter 28 may be manually reset after the tugging contest has ended, allowing the handler to use the device 10 with differing animals. In addition to the deflecting pointer type meters, the meter 28 may be configured as a digital readout, a numerical readout or bar graph to allow the handler to track the progress of the animal over time. The meter 28 may be manufactured out of ABS or a high impact plastic for example.

Operationally, an animal handler grabs the handle 14 of the device 10 placing fingers into the finger indentations 22. A mouthpiece 12 is placed in an animal's mouth. The animal is encouraged to bite the animal mouthpiece 12 such that the placement of the mouthpiece 12 provides an approximately uniform stress distribution over the gripping teeth of the animal. To aid in the distribution of force, the stubbles 20 allow the animal to bite the animal mouth piece 12 without slippage. The animal is then encouraged to pull on the animal mouthpiece 12 when the handle 14 is being held by the handler. This pulling causes a force to be exerted on the resistance arrangement 46. The animal or the handler may provide further force increasing the total force on the resistance arrangement 46. The measuring unit 48 of the circuit 60 measures the resistance arrangement 46 and communicates the status of the arrangement 46 to the processing unit 50. The processing unit 50 checks the status of the arrangement 46 against preset levels and determines if the preset levels have been exceeded. If the preset levels have been exceeded, the loudspeaker 26 is activated and acknowledgment of the achieved level is broadcast. The broadcast may be varied based upon a randomizing function. A resistence meter 28, coupled to the resistance arrangement 46 allows for a visual identification of the maximum force achieved on the device 10 by the animal and the animal handler.

In the foregoing specification, the invention has been described with reference to specific exemplary embodiments thereof It will, however, be evident that various modifications and changes may be made thereunto without departing from the broader spirit and scope of the invention as set forth in the appended claims. The specification and drawings are accordingly to be regarded in an illustrative rather than a restrictive sense.

What is claimed is:

1. An animal play toy comprising:
a housing defining an interior volume;
an animal mouthpiece;
a handle connected to the housing; and
a resistance arrangement connected to the animal mouthpiece and the handle, the resistance arrangement positioned in the interior volume.

2. The animal play toy according to claim 1, further comprising:
a circuit configured to measure a force in the resistance arrangement and provide an output of information based upon the measurement.

3. The animal play toy according to claim 2, wherein the circuit is configured to have a loudspeaker.

4. The animal play toy according to claim 2, wherein the circuit is configured with a power source.

5. The animal play toy according to claim 4, wherein the power source is configured to be replaced.

6. The animal play toy according to claim 4, wherein the power source is positioned in the interior volume.

7. The animal play toy according to claim 1, wherein the animal mouthpiece is configured with a stubble surface.

8. The animal play toy according to claim 1, wherein the handle is configured with finger indentations.

9. The animal play toy according to claim 1, wherein the animal mouthpiece is configured to rotate.

10. The animal play toy according to claim 1, wherein the mouthpiece is arranged with two sides and a rope connecting the two sides.

11. The animal play toy according to claim 1, further comprising:
a meter connected to the resistance arrangement.

12. The animal play toy according to claim 1, wherein the resistance arrangement is configured with a first spring and a second spring.

13. The animal play toy according to claim 12, wherein the first spring and second spring are connected in series.

14. The animal play toy according to claim 13, wherein the first spring is configured with a spring constant lower than a spring constant of the second spring.

15. The animal play toy according to claim 1, wherein the housing is configured into a first part and a second part.

16. The animal play toy according to claim 15, wherein the first part and second part are joined by a connection arrangement.

17. The animal play toy according to claim 16, wherein the connecting arrangement is configured through set screws.

18. The animal play toy according to claim 1, further comprising;
a meter configured to measure the resistance arrangement.

19. A method of playing with an animal comprising:
gripping a handle;
placing a mouthpiece in an animal's mouth;
creating a force between the handle and the mouthpiece; and
measuring the force between the handle and the mouthpiece.

20. The method of playing with an animal according to claim 19, further comprising:
providing a feedback based upon the measuring of the force.

21. The method of play with an animal according to claim 20, wherein the providing of the feedback is through a loudspeaker.
